(19) United States
(12) Patent Application Publication
(10) Pub. No.: US 2008/0285741 A1
(43) Pub. Date: Nov. 20, 2008

(54) TELEPHONE INTERFACE CIRCUIT

(75) Inventor: Yoshinobu Fujiwara, Tokyo (JP)

Correspondence Address: INTELLECTUAL PROPERTY / TECHNOLOGY LAW, PO BOX 14329, RESEARCH TRIANGLE PARK, NC, 27709, US

(73) Assignee: UNIDEN CORPORATION, Tokyo (JP)

(21) Appl. No.: 11/749,727

(22) Filed: May 16, 2007

(51) Int. Cl. H04M 1/738

(52) U.S. Cl. 379/412

(57) ABSTRACT

A telephone interface circuit has a first transistor for opening and closing a connection between a speech circuit and a pair of subscriber lines, a second transistor for controlling ON/OFF states of the first transistor, and a positive feedback circuit for positively feeding back, to a base terminal of the second transistor, a part of collector current flowing through the first transistor. A circuit constant is set such that when normal use voltage is applied to the pair of subscriber lines, the second transistor operates in a saturation region, and when voltage exceeding the normal use voltage is applied to the pair of subscriber lines, the second transistor operates in a non-saturation region.

### BACKGROUND

The present invention relates to an interface circuit for protecting a telephone from transient excess voltage, such as a surge voltage, and from excess current that flows continuously due to fault contact between a commercial power line and a pair of subscriber lines.

In a pair of subscriber lines suspended in the air, there is a possibility transient propagation of induced lightning caused by lightning strike or of continuous flow of excess current over a relatively long period of time due to fault contact (shorting) with commercial power lines. For this reason a protective circuit is provided in a telephone interface circuit that is installed between the telephone and the pair of subscriber lines. As the measures for preventing lightning surges, there are known a configuration in which, for example, a varistor element is connected between a pair of subscriber lines, and a configuration in which a varistor element is connected between earth and a pair of subscriber lines. If transient surge voltage exceeding the varistor voltage is applied to the pair of subscriber lines, the varistor element shifts into a conductive mode, whereby the surge voltage is absorbed and the speech circuit within the telephone is protected.

Also, as a countermeasure against generation of heat in the telephone or the telephone catching fire due to fault contact between the subscriber line and a commercial power line, there is known a configuration in which, for example, a PTC thermistor (positive temperature coefficient thermistor) is connected to an interface between the subscriber line and the telephone. If excess currents flow successively into the PTC thermistor over a certain period of time, the input impedance of the interface is increased by the increase in temperature of this element, whereby inflow of the excess currents flowing into the interior of the telephone can be suppressed.

### SUMMARY

However, in a telephone interface circuit in which a semiconductor element is used for opening/closing the connection between the speech circuit and the subscriber line, it was necessary to strictly observe the current and voltage ratings in order to avoid a secondary breakdown phenomenon that is peculiar to semiconductor elements, and use of an expensive SIDAC® was indispensable.

Therefore, it is an object of the present invention to provide an inexpensive telephone interface circuit, while maintaining reliability of the interface circuit, in order to protect the telephone from inflow of excessive currents.

In order to achieve the above object, a telephone interface circuit according to the present invention has a first transistor for opening and closing the connection between a speech circuit and a pair of subscriber lines, a second transistor for controlling ON/OFF states of the first transistor, and a positive feedback circuit for positively feeding back, to a base terminal of the second transistor, a part of collector current flowing through the first transistor. A circuit constant is set such that when normal use voltage is applied to the pair of subscriber lines, the second transistor operates in a saturation region, and when voltage exceeding the normal use voltage is applied to the pair of subscriber lines, the second transistor operates in a non-saturation region.

When the excess voltage is applied to the pair of subscriber lines, the second transistor operates in the non-saturation region, whereby the first transistor, second transistor, and positive feedback circuit function as an automated pulse generator, and start to oscillate while switching between an ON state and an OFF state alternately, whereby excess current flowing through the first transistor can be blocked intermittently. Accordingly, the average value of the excess current flowing through the first transistor can be reduced significantly, whereby the first transistor can be protected from the excess current.

Here, the circuit constant is for determining base current of the second transistor. A border between the saturation region and the non-saturation region of the second transistor can be set in accordance with the value of the base current.

### DESCRIPTION OF DRAWINGS

FIG. 1 is a circuit diagram of a telephone interface circuit according to the present embodiment;

FIG. 2 is a circuit diagram that is obtained by correcting the circuit diagram shown in FIG. 1, in order to compare this circuit diagram with a multi-vibrator; and

FIG. 3 is a graph showing the static characteristics of a transistor.

### DETAILED DESCRIPTION

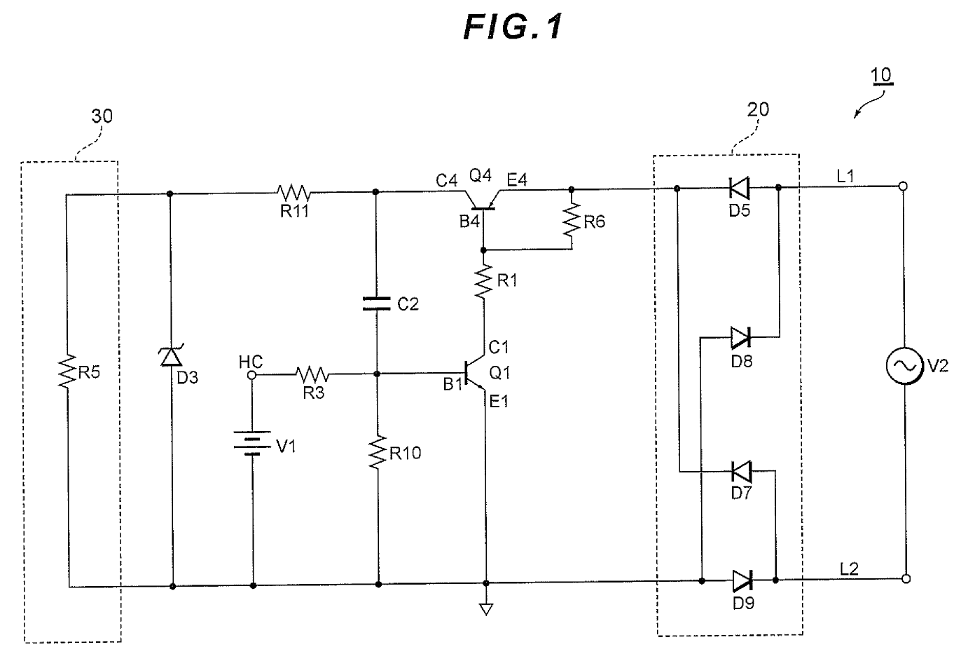

FIG. 1 shows a circuit configuration of a telephone interface circuit 10 according to the present embodiment.

The telephone interface circuit 10 controls interfacing between a speech circuit 30 and a pair of subscriber lines L1, L2. The telephone interface circuit 10 mainly has a diode bridge 20 for rectifying a signal flowing through the pair of subscriber lines L1 and L2 and supplies this signal to the speech circuit 30, a transistor Q4 for opening and closing the connection between the speech circuit 30 and the pair of subscriber lines L1 and L2, a transistor Q1 for switching between ON state and OFF state of the transistor Q4, and a Zener diode D3 for absorbing excess voltage applied to the subscriber lines L1 and L2.

The diode bridge 20 is constituted by four diodes D5, D8, D7 and D9.

The transistor Q4 is turned on during “off hook” and connects the pair of subscriber lines L1, L2 with the speech circuit 30. The transistor Q4 is turned off during “on hook” and disconnects the pair of subscriber lines L1, L2 from the speech circuit 30.

An emitter terminal E4 of the transistor Q4 is connected with the subscriber line L1.

A base terminal B4 of the transistor Q4 is connected with a collector terminal C1 of the transistor Q1 via a resistor R1.

A resistor R6 is connected between the emitter terminal E4 of the transistor Q4 and the base terminal B4 of the transistor Q4.

A base terminal B1 of the transistor Q1 is divided into three parts, one of which is connected with a collector terminal C4 of the transistor Q4 via a capacitor C2, another one of which is connected with a terminal HC via a resistor R3, and the other one of which is connected with the subscriber line L2 via a resistor R10.

The collector terminal C4 of the transistor Q4 is connected with the speech circuit 30 via a resistor R11.

It should be noted that the transistor Q4 is a PNP transistor, and the transistor Q1 is an NPN transistor. Also, an R5 indicates an input impedance of the speech circuit 30.

The terminal HC is connected with a microcomputer (not shown). The microcomputer (not shown) controls voltage V1 of the terminal HC and thereby controls base potential of the transistor Q1, when performing off-hook operation or on-hook operation and when transmitting a dial pulse.

For example, during “off hook”, the voltage V1 of the terminal HC is controlled to be high by the control of the microcomputer (not shown). Consequently, the base potential of the transistor Q1 is increased by the increase of the potential of the terminal HC, whereby the transistor Q1 is turned on. Then, since base potential of the transistor Q4 is increased, the transistor Q4 is turned on. Increased collector potential of the transistor Q4 is positively fed back to the base terminal B1 of the transistor Q1 via the capacitor C2, which is a positive feedback circuit. In the case in which line voltage V2 between the pair of subscriber lines L1 and L2 is within a normal use range, the circuit constant for determining the value of the base current of the transistor Q1 is selected such that an operating point of the transistor Q1 operates in the saturation region, thus the oscillating conditions are not satisfied. For this reason, during “off hook”, the transistor Q4 keeps the ON state as long as the line voltage V2 between the pair of subscriber lines L1 and L2 is within the normal use range.

When dial input is performed during “off hook”, the microcomputer (not shown) controls the voltage V1 of the terminal HC in response to the dial input. Accordingly, the transistor Q1 transmits a dial pulse signal.

When, on the other hand, the line voltage V2 between the pair of subscriber lines L1 and L2 exceeds the normal use voltage during “off hook”, the circuit constant for determining the value of the base current of the transistor Q1 is selected such that the operating point of the transistor Q1 operates in the non-saturation region, thus the oscillating conditions are satisfied. Once the oscillating conditions are satisfied, the pair of transistors Q1 and Q4 start to oscillate in accordance with the same oscillation principle as the multi-vibrator. Consequently, loop current flowing through the transistor Q4 is blocked intermittently, thus the transistor Q4 can be protected from excess current.

During “on hook”, the voltage V1 of the terminal HC is controlled to be low by the control of the microcomputer (not shown). Then, the base potential of the transistor Q1 decreases, and the transistor Q1 is turned off. Consequently, the base potential of the transistor Q4 decreases, whereby the transistor Q4 is turned off.

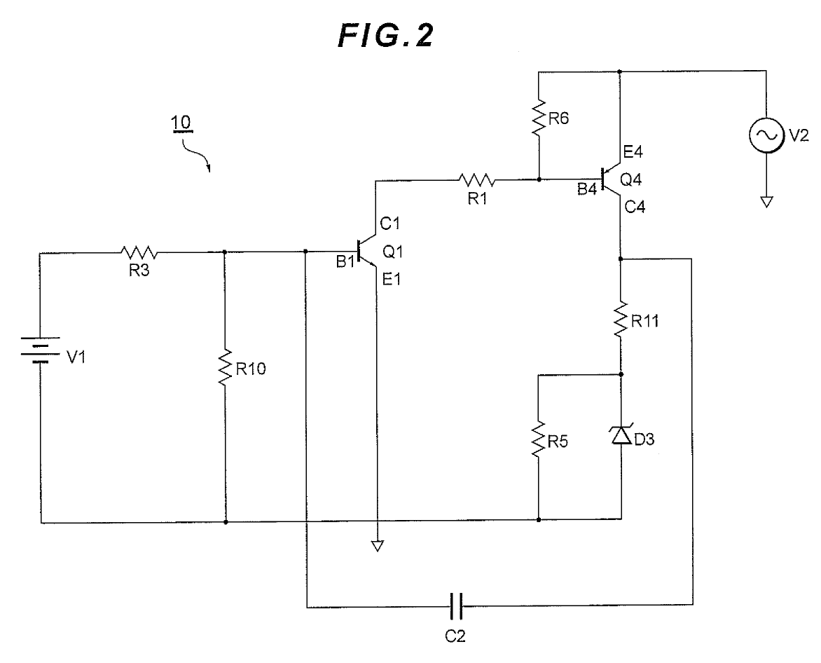

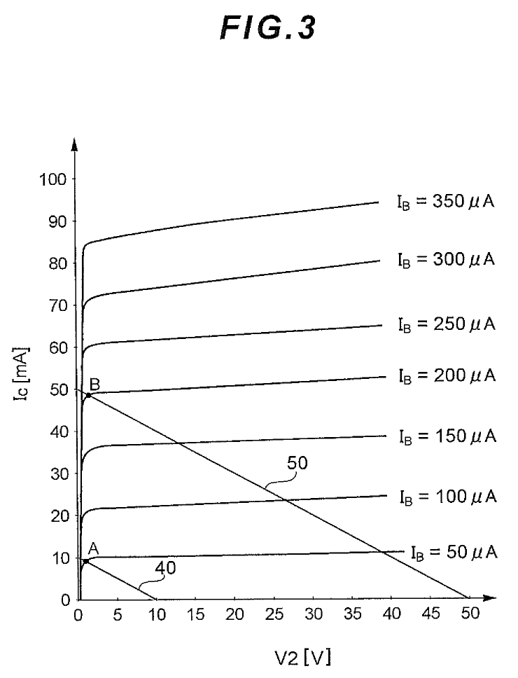

Next, a principle in which the transistors Q1 and Q4 oscillate when excess voltage is applied to the pair of subscriber lines L1 and L2 is described with reference to FIG. 2 and FIG. 3.

FIG. 2 is a circuit diagram that is obtained by correcting the telephone interface circuit 10 (however, illustration of the diode bridge 20 is omitted for convenience of explanation).

As shown in FIG. 2, a part of collector current flowing through the transistor Q4 is positively fed back to the base terminal B1 of the transistor Q1. Therefore, a non-inverting amplifier circuit is constituted by the pair of transistors Q1 and Q4.

As described above, when excess voltage is applied to the pair of subscriber lines L1 and L2, the circuit constant is selected such that the transistor Q1 operates in the non-saturation region, thus the pair of transistors Q1 and Q4 start to oscillate in accordance with the same oscillation principle as the multi-vibrator (or the automated pulse generator). Once the oscillating operation is started, the pair of transistors Q1 and Q4 repeatedly switch between the ON state and OFF state alternately on a cycle proportional to a time constant C2R3. For example, while the transistor Q1 is in the OFF state at a certain moment, the transistor Q4 is also in the OFF state. Also, the voltage V1 of the terminal HC is set to high voltage at this certain moment, the potential of one of the pair of electrodes constituting the capacitor C2 becomes higher than the potential of the other electrode, the former electrode being connected with the base terminal B1 of the transistor Q1, whereby the transistor Q1 eventually shifts into the ON state, while the transistor Q4 shits into the OFF state. Switching alternately between the ON state and OFF state of the pair of transistors Q1 and Q4 is repeated by means of discharge and charge of the capacitor C2. This repetition cycle Tm is approximately 0.69×C2×R3.

FIG. 3 shows the static characteristics of the transistor Q1.

The horizontal axis shown in FIG. 3 indicates the line voltage V2, while the vertical axis indicates the collector current I_{c} flowing through the transistor Q1. The reference numeral 40 indicates a load line obtained when the line voltage V2 is within the range of the normal use voltage, and the reference numeral 50 indicates an example of a load line obtained when the line voltage V2 exceeds the normal use voltage range.

Here, the base current flowing through the transistor Q1 is expressed as I_{B}, a DC amplification factor of the transistor Q1 is expressed as h_{FE}, and the base-emitter voltage of the transistor Q4 and the collector-emitter voltage of the transistor Q1 with respect to the line voltage V2 are ignored, whereby the following equations are established:

I_{B}=(V1−0.6)/R3=I_{C}/h_{FE} (1)

I_{C}=V2/R1 (2)

Here, when the equation (2) is substituted for the equation (1) to obtain V2, the following equation is established:

V2=(V1−0.6)×R1h_{FE}/R3 (3)

For example, when V1=3.3V, R1=1.0KΩ, h_{FE}=40, and R3=10KΩ, V2=10.8V is obtained. This result means that the transistor Q1 operates in the non-saturation region when the line voltage V2 is more than 10.8V, and that the transistor Q1 operates in the saturation region when the line voltage V2 is less than 10.8V.

When the line voltage V2 is 10V (when the line voltage V2 is within the normal use voltage range), in order to allow the transistor Q1 to enter the saturation region, a base current I_{B} of 50 μA is required, as shown by the intersecting point A between the static characteristic curve of the transistor Q1 and the load line 40. In the present embodiment, the circuit constant for determining the value of the base current I_{B} flowing through the transistor Q1 is selected such that the operating point of the transistor Q1 enters the saturation region when the line voltage V2 is within the normal use voltage range. In the saturation region, the transistor Q1 does not have an amplifying function. Therefore, even when a part of the collector current of the transistor Q4 is positively fed back to the base terminal B1 of the transistor Q4 via the capacitor C2, the oscillating conditions are not satisfied.

When the line voltage V2 is 50V (when the line voltage V2 exceeds the normal use voltage), in order to allow the transistor Q1 to enter the saturation region, a base current I_{B} of 200 μA is required, as shown by the intersecting point B between the static characteristic curve of the transistor Q1 and the load line 50. In the present embodiment, the circuit constant for determining the value of the base current I_{B} flowing through the transistor Q1 is selected such that the operating point of the transistor Q1 enters the non-saturation region when the line voltage V2 exceeds the normal use voltage. In the non-saturation region, the transistor Q1 has the amplifying function. Therefore, the oscillating conditions are satisfied, and the pair of transistors Q1 and Q4 start the oscillating operation.

This oscillating operation starts as soon as excess voltage is applied to the pair of subscriber lines L1 and L2, thus excess current passing through the transistor Q4 is blocked at the moment when the excess voltage is applied to the pair of subscriber lines L1 and L2. When the repetition cycle Tm progresses after the excess current is blocked, excess current starts to flow through the transistor Q4 again, but the excess current is blocked again at the moment when the excess current starts to flow. In this manner, excess current flowing through the transistor Q4 is blocked intermittently. By adjusting the value of the time constant C2R3 to an appropriate value, the ratio between, for example, a time period in which excess voltage is applied between the pair of subscriber lines L1 and L2 and a time period in which excess current flows through the transistor Q4 during the abovementioned period can be set to approximately 10:1. Therefore, the average value of the excess current flowing through the transistor Q4 can be reduced significantly.

The oscillating operation performed by the transistors Q1 and Q4 continues over a period of time during which excess voltage is applied to the pair of subscriber lines L1 and L2 (i.e., a period during which the oscillating conditions are satisfied), and thereafter, when the line voltage V2 decreases to fall within the range of the normal use voltage, the operating point of the transistor Q1 returns to the saturation region again, whereby the oscillating conditions are not satisfied and the oscillating operation stops. Accordingly, the protective function of the transistor Q4 of the telephone interface circuit 10 has a self-reset function, thus the pair of subscriber lines L1 and L2 can be used normally from the moment when excess voltage is no longer applied to the subscriber lines.

It should be noted that the voltage V1 of the terminal HC, the resistor R3 or the like can be used as the circuit constant for determining the value of the base current I_{B} flowing through the transistor Q1, but the circuit constant is not limited to these elements.

What is claimed is:

1. A telephone interface circuit, comprising:
a first transistor for opening and closing a connection between a speech circuit and a pair of subscriber lines;
a second transistor for controlling ON/OFF states of the first transistor; and
a positive feedback circuit for positively feeding back, to a base terminal of the second transistor, a part of collector current flowing through the first transistor,
wherein a circuit constant is set such that when normal use voltage is applied to the pair of subscriber lines, the second transistor operates in a saturation region, and when voltage exceeding the normal use voltage is applied to the pair of subscriber lines, the second transistor operates in a non-saturation region.

2. The telephone interface circuit according to claim 1, wherein the circuit constant determines base current of the second transistor.

3. The telephone interface circuit according to claim 1, wherein when the excess voltage is applied to the pair of subscriber lines, the first transistor and the second transistor repeatedly oscillate while switching between the ON state and the OFF state alternately.
